(19) United States
(12) Patent Application Publication
(10) Pub. No.: US 2019/0320239 A1
(43) Pub. Date: Oct. 17, 2019

(54) VIEWER-INTERACTIVE ENHANCED VIDEO ADVERTISEMENTS

(71) Applicant: Michael Stephen Kokernak, Boston, MA (US)

(72) Inventor: Michael Stephen Kokernak, Boston, MA (US)

(21) Appl. No.: 15/953,138

(22) Filed: Apr. 13, 2018

(51) Int. Cl. H04N 21/81; G06Q 30/02; H04N 21/8545; H04N 21/8358; H04N 21/472

(52) U.S. Cl. CPC H04N 21/812; G06Q 30/0246; H04N 21/47217; H04N 21/8358; H04N 21/8545

(57) ABSTRACT

The present disclosure relates to a system and method to enhance user interaction experience with a data transport stream displayed as advertisements on a computing device. The method include the steps of receiving, a data transport stream having at least one uniquely identified token along with one or more clickable moments inserted in one or more elementary data stream components of a said data transport stream, by a computing device; displaying, on a user interface of the computing device, said data transport stream to one or more users, wherein said one or more clickable moments are displayed, in real-time, along with said data transport stream; and transmitting, by the computing device, in real-time, one or more user interactions of the users, responsive to clicking on the user interface by said users while said one or more clickable moments are being displayed, to one or more repositories.

### FIELD OF THE INVENTION

The present disclosure relates generally to the field of interactive advertising, and more particularly, to system and method for enhancing user interaction experience with a data transport stream (content) displayed as advertisements on a computing device.

### BACKGROUND

The background description includes information that may be useful in understanding present invention. It is not an admission that any of the information provided herein is prior art or relevant to the presently claimed invention, or that any publication specifically or implicitly referenced is prior art.

As Internet bandwidth capabilities increase, on-demand video continues to grow in popularity. The concurrent growth in social media technology facilitates the generation of vast amounts of meta-content. Such meta-content often includes postings on social media web sites (e.g., Twitter, Facebook, and MySpace), commenting or reviewing on-demand video that is available for download via the Internet.

TV programming and videos are an integral part of daily life; examples include nightly news, movies, comedy shows, drama shows, reality TV, musicals, a movie on DVD, YouTube etc. (collectively referred from hereon as Programs). Videos can also be viewed over the internet, some are streaming and others are retrieved and displayed. With the advent of YouTube, growth in wireless bandwidth, wider usage of smart phones, tablets, other wireline and wireless devices, smart TVs, state of the art gaming consoles etc. The conventional definitions have somewhat blurred among various delivery mechanisms. The same holds true for viewing devices. Most videos are monetized in the form of the revenue generated via the advertisements while some are supported by subscription services such as Hulu, Netflix and others. Historically, advertisements generally appear at the beginning, and often in the middle of a video and sometimes at the end as well. In the case of on-line viewing, a viewer can typically click on the ad and he(s)he is taken to a landing page of the advertiser, whereas in the case of watching TV, the ads are not clickable by the viewer even though many TV sets are directly or indirectly connected to internet these days.

With the rapid growth of multimedia technology, a variety of multimedia customer electronics (CEs) for playing moving images have been developed. In particular, with the commencement of digital multimedia broadcasting (DMB) services using various broadcasting media including terrestrial broadcasting, satellite broadcasting, and cable broadcasting, compact multimedia devices with diverse functions have been developed.

DMB services include diverse media data such as video, audio, text, hyperlinks, and still images. In particular, a hyperlink is used to provide diverse additional information related with a moving image. The hyperlink is manifested as an object in a particular region on a screen on which the moving image is displayed. When a user watching the moving image clicks on the object in the particular region, predefined additional content may be played or a particular action related with the moving image may be executed. Hereinafter, among objects such as characters and properties included in a moving image, an object such as a selectable button that is assigned a particular action is referred to as a “clickable object”.

Online advertising may be an important source of revenue for enterprises engaged in electronic commerce. A number of different types of web page based online advertisements (ads) are currently in use, along with various associated distribution requirements, advertising metrics, and pricing mechanisms. Processes implemented with technologies such as Hypertext Markup Language (HTML) and Hypertext Transfer Protocol (HTTP) enables a web page to be configured to contain a location for inclusion of an advertisement (ad). A page may not only be a web page, but any other electronically created page or document. An advertisement may be selected for display within the page each time the page is requested, for example, by a browser or server application.

Hyperlinks are widely used in electronic text documents and typically implemented with a browser (i.e., web browser). A hyperlink may be considered as a connection between an element, such as a word, phrase, symbol or object in a document, such as a hypertext document, with a different element in the same document, another document, file or script. The hyperlink may be activated by a user clicking on the hyperlink through an interactive user device such as mouse. When the user clicks on the hyperlink, the browser may be redirected to the clement or other document. The concept of hyperlink may also be used on images, particularly as a “map” tag on images in hypertext markup language. For example, when a user clicks on a region having the map tag, the browser is redirected to the linked webpage.

However, there is a challenge that the ads may change between conventional TV viewing and on-line viewing. For example a viewer watches Saturday Night Live (SNL) on his TV when it first airs, and saw an ad of a man's fragrance that interests him, but continued watching the show and forgot the fragrance's name. When he goes online to review the episode of SNL the next day on the NBC website to look for that cologne, the advertisements are different and the viewer is unable to capitalize on his interest and is disappointed and/or frustrated. The Merchants also miss out on this monetization opportunity.

Accordingly, given the extensive consumer acceptance and widespread interest in such videos or multimedia contents, there is always a need for better ways to commercialize the economic value generated from these video or multimedia contents. Also, advertisers are particularly worry in using new technologies that do not provide the most secure methods available to protect their customer data.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

### SUMMARY

The present disclosure relates generally to the field of interactive advertising, and more particularly, to system and method for enhancing user interaction experience with a data transport stream (content) displayed as advertisements on a computing device.

Embodiment of the present disclosure provides a system (a platform) and method that enhances user interaction experience with a data transport stream (content) displayed as advertisements on a computing device.

An aspect of the present disclosure relates to a computing device to enhance user interaction experience with a data transport stream displayed as advertisements on said computing device. The system includes a non-transitory storage device having embodied therein one or more routines operable to enhance user interaction experience with a data transport stream displayed as advertisements on said computing device; and one or more processors coupled to the non-transitory storage device and operable to execute the one or more routines.

The one or more routines include a user interaction engine enables to receive, said data transport stream having at least one uniquely identified token along with one or more clickable moments inserted in one or more elementary data stream components of a said data transport stream. The user interaction engine enables to display, on a user interface of the computing device, said data transport stream to one or more users, wherein said one or more clickable moments are displayed, in real-time, along with said data transport stream. The user interaction engine can transmit in real-time, one or more user interactions of the users, responsive to clicking on the user interface by said users while said one or more clickable moments are being displayed, to one or more repositories.

In an aspect, the user interaction engine can be configured to bookmark, responsive to clicking, said clickable moments if one or more engagement rules defined in said response repository associated with a metadata created at the time of insertion of the uniquely identified token in said elementary data stream components.

In an aspect, the user interaction engine can enable to open a new web page, responsive to clicking, having a link embedded in said clickable moments if one or more engagement rules defined in said response repository associated with a metadata created at the time of insertion of the uniquely identified token in said elementary data stream components.

In an aspect, one or more clickable moments can be displayed as non-obtrusive graphical watermark while said data transport stream is displayed to one or more users.

In an aspect, uniquely identified token can be associated with a packet ID (PID) of at least one packet generated by a database.

In an aspect, uniquely identified token can be parsable and/or filtered while said data transport stream is displayed to one or more users such that said users, by clicking on the user interface, engages with one or more contents associated with said uniquely identified token to remember (bookmark) the experience or enable a deeper viewing or interactive experience in real-time.

In an aspect, data transport stream can be a video transport stream.

An aspect of the present disclosure relates to a method. The method includes steps of receiving, a data transport stream having at least one uniquely identified token along with one or more clickable moments inserted in one or more elementary data stream components of a said data transport stream, by a computing device; displaying, on a user interface of the computing device, said data transport stream to one or more users, wherein said one or more clickable moments are displayed, in real-time, along with said data transport stream; and transmitting, by the computing device, in real-time, one or more user interactions of the users, responsive to clicking on the user interface by said users while said one or more clickable moments are being displayed, to one or more repositories.

In an aspect, the method can include further step of transmitting, by the computing device, in real-time, one or more user interactions of the users, responsive to clicking on the user interface by said users while said one or more clickable moments are being displayed, to one or more repositories.

An aspect of the present disclosure relates to a computing device to enhance user interaction experience with a data transport stream displayed as advertisements on said computing device. The system includes a non-transitory storage device having embodied therein one or more routines operable to enhance user interaction experience with a data transport stream displayed as advertisements on said computing device; and one or more processors coupled to the non-transitory storage device and operable to execute the one or more routines.

The one or more routines include a user interaction engine enables to embed at least one uniquely identified token along with one or more clickable moments in one or more elementary data stream components of a said data transport stream. The user interaction engine displays, on a user interface of said one or more electronic devices, said data transport stream to one or more users, wherein said one or more clickable moments are displayed, in real-time, along with said data transport stream. The user interaction engine can receive, in real-time, one or more user interactions of the users responsive to clicking on the user interface by said users while said one or more clickable moments are being displayed. The user interaction engine can utilize said one or more user interactions of the users to enhance one or more user requirements in future data transport stream.

An aspect of the present disclosure relates to a method. The method includes steps of embedding, by a computing device, at least one uniquely identified token along with one or more clickable moments in one or more elementary data stream components of a said data transport stream; displaying, on a user interface of said one or more electronic devices, said data transport stream to one or more users, wherein said one or more clickable moments are displayed, in real-time, along with said data transport stream; receiving, in real-time, one or more user interactions of the users responsive to clicking on the user interface by said users while said one or more clickable moments are being displayed; and utilizing said one or more user interactions of the users to enhance one or more user requirements in future data transport stream.

Various objects, features, aspects and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure, and wherein:

FIG. 1 illustrates a network implementation of a proposed system, in accordance with an exemplary embodiment of the present disclosure

FIG. 2 illustrates exemplary functional modules of the proposed interaction engine, in accordance with an exemplary embodiment of the present disclosure.

FIG. 3 illustrates exemplary functional modules of the proposed interaction engine, in accordance with an exemplary embodiment of the present disclosure.

FIG. 4 illustrates a high level block diagram and exemplary working of the proposed system, in accordance with an exemplary embodiment of the present disclosure.

FIG. 5 illustrates an integration of a proposed system within a cisco based cable head-end infrastructure and exemplary working of the proposed system, in accordance with an exemplary embodiment of the present disclosure.

FIG. 6 illustrates an exemplary flow diagram representing method performed by the proposed system, in accordance with an exemplary embodiment of the present disclosure.

FIG. 7 illustrates another exemplary flow diagram representing method performed by the proposed system, in accordance with an exemplary embodiment of the present disclosure.

FIG. 8 illustrates an exemplary computer system utilized for implementation of the proposed system in accordance with an exemplary embodiment of the present disclosure.

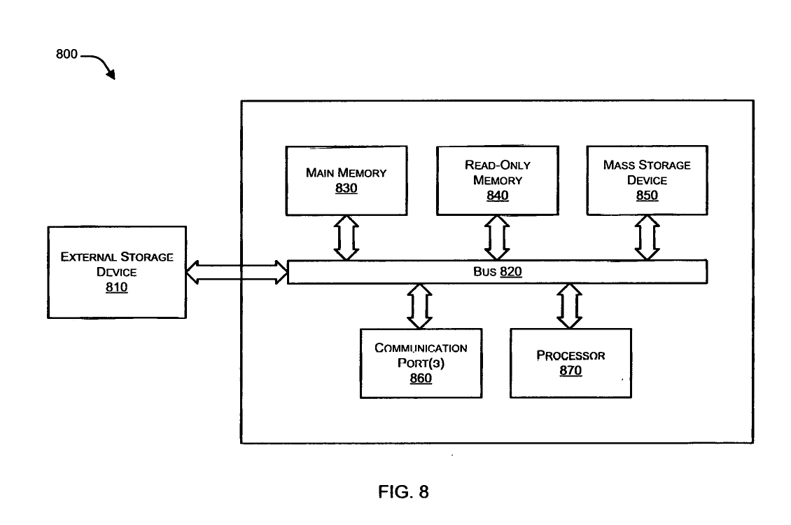

### DETAILED DESCRIPTION OF THE INVENTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition persons in the pertinent art have given that term as reflected in printed publications and issued patents at the time of filing.

The present disclosure relates generally to the field of advertisement, and more particularly, to a system and method to enhance user interaction experience with a data transport stream displayed as advertisements on a computing device.

The present disclosure to a system and method for enhancing user interaction experience with a data transport stream (content) displayed as advertisements on a computing device.

An aspect of the present disclosure relates to a computing device to enhance user interaction experience with a data transport stream displayed as advertisements on said computing device. The system includes a non-transitory storage device having embodied therein one or more routines operable to enhance user interaction experience with a data transport stream displayed as advertisements on said computing device; and one or more processors coupled to the non-transitory storage device and operable to execute the one or more routines.

The one or more routines include a user interaction engine enables to receive, said data transport stream having at least one uniquely identified token along with one or more clickable moments inserted in one or more elementary data stream components of a said data transport stream. The user interaction engine enables to display, on a user interface of the computing device, said data transport stream to one or more users, wherein said one or more clickable moments are displayed, in real-time, along with said data transport stream. The user interaction engine can transmit in real-time, one or more user interactions of the users, responsive to clicking on the user interface by said users while said one or more clickable moments are being displayed, to one or more repositories

In an aspect, the user interaction engine can be configured to bookmark, responsive to clicking, said clickable moments if one or more engagement rules defined in said response repository associated with a metadata created at the time of insertion of the uniquely identified token in said elementary data stream components.

In an aspect, the user interaction engine can enable to open a new web page, responsive to clicking, having a link embedded in said clickable moments if one or more engagement rules defined in said response repository associated with a metadata created at the time of insertion of the uniquely identified token in said elementary data stream components.

In an aspect, one or more clickable moments can be displayed as non-obtrusive graphical watermark while said data transport stream is displayed to one or more users.

In an aspect, uniquely identified token can be associated with a packet ID (PID) of at least one packet generated by a database.

In an aspect, uniquely identified token can be parsable and/or filtered while said data transport stream is displayed to one or more users such that said users, by clicking on the user interface, engages with one or more contents associated with said uniquely identified token to remember (bookmark) the experience or enable a deeper viewing or interactive experience in real-time.

In an aspect, data transport stream can be a video transport stream.

An aspect of the present disclosure relates to a method. The method includes steps of receiving, a data transport stream having at least one uniquely identified token along with one or more clickable moments inserted in one or more elementary data stream components of a said data transport stream, by a computing device; displaying, on a user interface of the computing device, said data transport stream to one or more users, wherein said one or more clickable moments are displayed, in real-time, along with said data transport stream; and transmitting, by the computing device, in real-time, one or more user interactions of the users, responsive to clicking on the user interface by said users while said one or more clickable moments are being displayed, to one or more repositories.

In an aspect, the method can include further step of transmitting, by the computing device, in real-time, one or more user interactions of the users, responsive to clicking on the user interface by said users while said one or more clickable moments are being displayed, to one or more repositories.

In an embodiment, the Clickable TV experience can be enabled by inserting uniquely identified Tokens in the elementary data stream components of a video's transport stream. The Token can be associated with a Packet ID (PID). The unique Token can be parsed (PID filtered) and identified during video play out on a mobile device, desktop PC, or a digital set top box so that a viewer, if desired, may engage with the video content to remember (“bookmark”) the experience or enable a deeper viewing or interactive experience in real-time.

The engagement actions performed by viewers can be persistently stored in cloud based “Response Repository”, for subsequent use by a viewer for further interaction and fulfillment with the content and with advertisers, the cable operator, and system for revenue recognition and share.

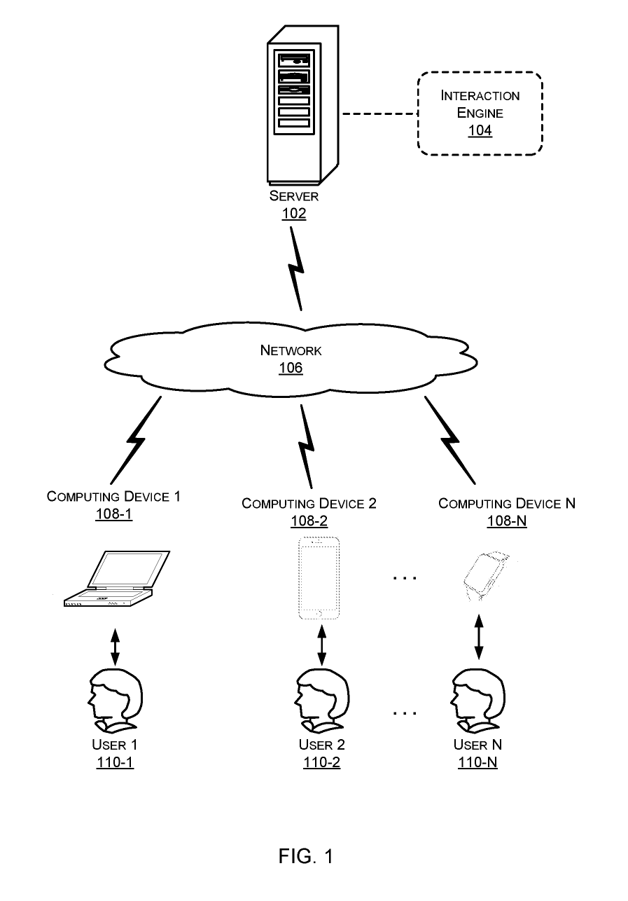

FIG. 1 illustrates a network implementation of a proposed system, in accordance with an exemplary embodiment of the present disclosure. It would be appreciated that aspects of the present disclosure can be applied to a variety of network architectures, all of which are well within the scope of the present disclosure.

In an aspect, network architecture of the present disclosure can include a proposed system having/connected with one or more Internet of Things (IoT) devices. In a typical network architecture of the present disclosure can include a plurality of network devices such as transmitter, receivers, and/or transceivers that may include one or more IoT devices.

As used herein, the IoT devices can be a device that includes sensing and/or control functionality as well as a WiFi™ transceiver radio or interface, a Bluetooth™ transceiver radio or interface, a Zigbee™ transceiver radio or interface, an Ultra-Wideband (UWB) transceiver radio or interface, a WiFi-Direct transceiver radio or interface, a Bluetooth™ Low Energy (BLE) transceiver radio or interface, and/or any other wireless network transceiver radio or interface that allows the IoT device to communicate with a wide area network and with one or more other devices. In some embodiments, an IoT device does not include a cellular network transceiver radio or interface, and thus may not be configured to directly communicate with a cellular network. In some embodiments, an IoT device may include a cellular transceiver radio, and may be configured to communicate with a cellular network using the cellular network transceiver radio.

IoT devices may include home automation network devices that allow a user to access, control, and/or configure various home appliances located within the user's home (e.g., a television, radio, light, fan, humidifier, sensor, microwave, iron, and/or the like), or outside of the user's home (e.g., exterior motion sensors, exterior lighting, garage door openers, sprinkler systems, or the like). Network device may include a home automation switch that may be coupled with a home appliance. In some embodiments, network devices may be used in other environments, such as a business, a school, an establishment, a park, or any place that can support a local area network to enable communication with network devices. For example, a network device can allow a user to access, control, and/or configure devices, such as office-related devices (e.g., copy machine, printer, fax machine, or the like), audio and/or video related devices (e.g., a receiver, a speaker, a projector, a DVD player, a television, or the like), media-playback devices (e.g., a compact disc player, a CD player, or the like), computing devices (e.g., a home computer, a laptop computer, a tablet, a personal digital assistant (PDA), a computing device, a wearable device, or the like), lighting devices (e.g., a lamp, recessed lighting, or the like), devices associated with a security system, devices associated with an alarm system, devices that can be operated in an automobile (e.g., radio devices, navigation devices), and/or the like.

A user may communicate with the network devices using an access device that may include any human-to-machine interface with network connection capability that allows access to a network. For example, the access device may include a stand-alone interface (e.g., a cellular telephone, a smartphone, a home computer, a laptop computer, a tablet, a personal digital assistant (PDA), a computing device, a wearable device such as a smart watch, a wall panel, a keypad, or the like), an interface that is built into an appliance or other device e.g., a television, a refrigerator, a security system, a game console, a browser, or the like), a speech or gesture interface (e.g., a Kinect™ sensor, a Wiimote™, or the like), an IoT device interface (e.g., an Internet enabled device such as a wall switch, a control interface, or other suitable interface), or the like. In some embodiments, the access device may include a cellular or other broadband network transceiver radio or interface, and may be configured to communicate with a cellular or other broadband network using the cellular or broadband network transceiver radio. In some embodiments, the access device may not include a cellular network transceiver radio or interface.

User may interact with the network devices using an application, a web browser, a proprietary program, or any other program executed and operated by the access device. In some embodiments, the access device may communicate directly with the network devices (e.g., communication signal). For example, the access device may communicate directly with network devices using Zigbee™ signals, Bluetooth™ signals, WiFi™ signals, infrared (IR) signals, UWB signals, WiFi-Direct signals, BLE signals, sound frequency signals, or the like. In some embodiments, the access device may communicate with the network devices via the gateways and/or a cloud network.

Local area network may include a wireless network, a wired network, or a combination of a wired and wireless network. A wireless network may include any wireless interface or combination of wireless interfaces (e.g., Zigbee™, Bluetooth™, WiFi™, IR, UWB, WiFi-Direct, BLE, cellular, Long-Term Evolution (LTE), WiMax™, or the like). A wired network may include any wired interface (e.g., fiber, Ethernet, powerline, Ethernet over coaxial cable, digital signal line (DSL), or the like). The wired and/or wireless networks may be implemented using various routers, access points, bridges, gateways, or the like, to connect devices in the local area network. For example, the local area network may include gateway and gateway. Gateway can provide communication capabilities to network devices and/or access device via radio signals in order to provide communication, location, and/or other services to the devices. The gateway is directly connected to the external network and may provide other gateways and devices in the local area network with access to the external network. The gateway may be designated as a primary gateway.

The network access provided by gateway may be of any type of network familiar to those skilled in the art that can support data communications using any of a variety of commercially-available protocols. For example, gateways may provide wireless communication capabilities for the local area network 100 using particular communications protocols, such as WiFi™ (e.g., IEEE 802.11 family standards, or other wireless communication technologies, or any combination thereof). Using the communications protocol(s), the gateways may provide radio frequencies on which wireless enabled devices in the local area network can communicate. A gateway may also be referred to as a base station, an access point, Node B, Evolved Node B (eNodeB), access point base station, a Femtocell, home base station, home Node B, home eNodeB, or the like.

Gateways may include a router, a modem, a range extending device, and/or any other device that provides network access among one or more computing devices and/or external networks. For example, gateway may include a router or access point or a range extending device. Examples of range extending devices may include a wireless range extender, a wireless repeater, or the like.

A router gateway may include access point and router functionality, and may further include an Ethernet switch and/or a modem. For example, a router gateway may receive and forward data packets among different networks. When a data packet is received, the router gateway may read identification information (e.g., a media access control (MAC) address) in the packet to determine the intended destination for the packet. The router gateway may then access information in a routing table or routing policy, and may direct the packet to the next network or device in the transmission path of the packet. The data packet may be forwarded from one gateway to another through the computer networks until the packet is received at the intended destination.

Referring now to FIG. 1, in an embodiment, FIG. 1 indicates a network implementation of a proposed system 100. Although the present subject matter is explained considering that the proposed system 100 is implemented as an application on a server 102, it may be understood that the proposed interaction engine 104 may also be implemented in a variety of computing systems, such as a laptop computer, a desktop computer, a notebook, a workstation, a server, a network server, a cloud-based environment and the like. It would be appreciated that the proposed interaction engine 104 may be accessed by multiple users 110-1, 110-2 . . . 110-N (collectively referred to as users 110 and individually referred to as the user 110 hereinafter), through one or more computing devices 108-1, 108-2 . . . 108-N (collectively referred to as computing devices 108 hereinafter), or applications residing on the computing devices 108. In an aspect, the proposed interaction engine 104 can be operatively coupled to a website and so be operable from any Internet enabled computing device 108. Examples of the computing devices 108 may include, but are not limited to, a portable computer, a personal digital assistant, a handheld device, and a workstation. The computing devices 108 are communicatively coupled to the proposed interaction engine 104 through a network 106. It may be also understood that the proposed interaction engine 104 is a wearable device to be worn by a user and having wearable technology, wearables, fashionable technology, wearable devices, tech togs, or fashion electronics embedded in them. The proposed interaction engine 104 can be smart electronic devices (electronic device with microcontrollers) that can be worn on the body as implant or accessories.

In one implementation, the network 106 can be a wireless network, a wired network or a combination thereof. The network 106 can be implemented as one of the different types of networks, such as intranet, local area network (LAN), wide area network (WAN), the internet, and the like. Further, the network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 104 can include a variety of network devices, including routers, bridges, servers, computing devices, storage devices, and the like.

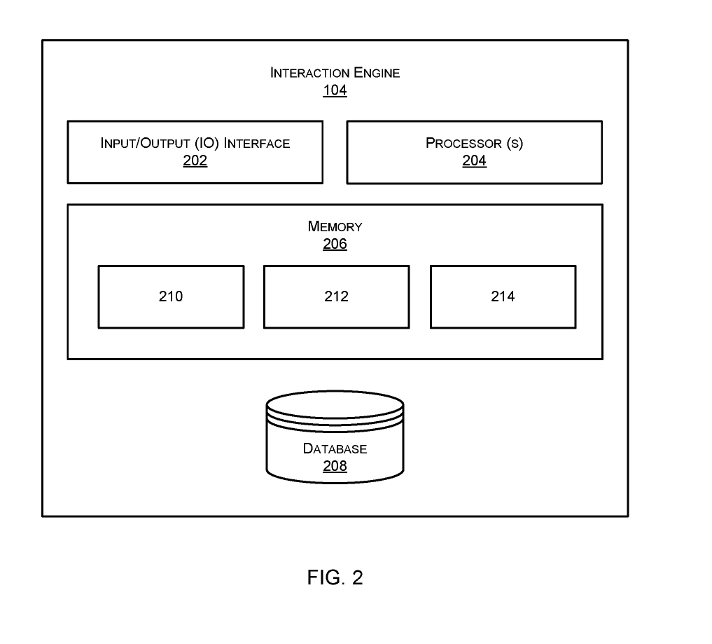

FIG. 2 illustrates exemplary functional modules of the proposed interaction engine 104, in accordance with an exemplary embodiment of the present disclosure. In one embodiment, the proposed interaction engine 104 may include at least one processor 204, an input/output (I/O) interface 202, a memory 206, and a database 208. The at least one processor 204 may be implemented as one or more microprocessors, microcomputers, microcontrollers, digital signal processors, central processing units, state machines, logic circuitries, and/or any devices that manipulate signals based on operational instructions. Among other capabilities, the at least one processor 204 is configured to fetch and execute computer-readable instructions stored in the memory 206.

The I/O interface 202 may include a variety of software and hardware interfaces, for example, a web interface, a graphical user interface, and the like. The I/O interface 202 may allow the proposed interaction engine 104 to interact with a user directly or through the client devices 108. Further, the I/O interface 202 may enable the proposed interaction engine 104 to communicate with other computing devices, such as web servers and external data servers (not shown). The I/O interface 202 can facilitate multiple communications within a wide variety of networks and protocol types, including wired networks, for example, LAN, cable, etc., and wireless networks, such as WLAN, cellular, or satellite. The I/O interface 202 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules, routines, programs, objects, components, data structures, etc., which perform particular tasks or implement particular abstract data types. In one implementation, the memory 206 may include one or more modules 210, 212 and 214.

In another exemplary embodiment, the proposed interaction engine 104 can be configured with a module 210 to receive, said data transport stream having at least one uniquely identified token along with one or more clickable moments inserted in one or more elementary data stream components of a said data transport stream. In another exemplary embodiment, the proposed interaction engine 104 can be configured with a module 212 to display, on a user interface of the computing device, said data transport stream to one or more users, wherein said one or more clickable moments are displayed, in real-time, along with said data transport stream. In another exemplary embodiment, the proposed interaction engine 104 can be configured with a module 214 to transmit, in real-time, one or more user interactions of the users, responsive to clicking on the user interface by said users while said one or more clickable moments are being displayed, to one or more repositories

In another exemplary embodiment, the proposed interaction engine 104 can be configured with a module 210 to embed at least one uniquely identified token along with one or more clickable moments in one or more elementary data stream components of a said data transport stream. In another exemplary embodiment, the proposed interaction engine 104 can be configured with a module 212 to display, on a user interface of said one or more electronic devices, said data transport stream to one or more users, wherein said one or more clickable moments are displayed, in real-time, along with said data transport stream. In another exemplary embodiment, the proposed interaction engine 104 can be configured with a module 212 to receive, in real-time, one or more user interactions of the users responsive to clicking on the user interface by said users while said one or more clickable moments are being displayed. In another exemplary embodiment, the proposed interaction engine 104 can be configured with a module 214 to utilize said one or more user interactions of the users to enhance one or more user requirements in future data transport stream.

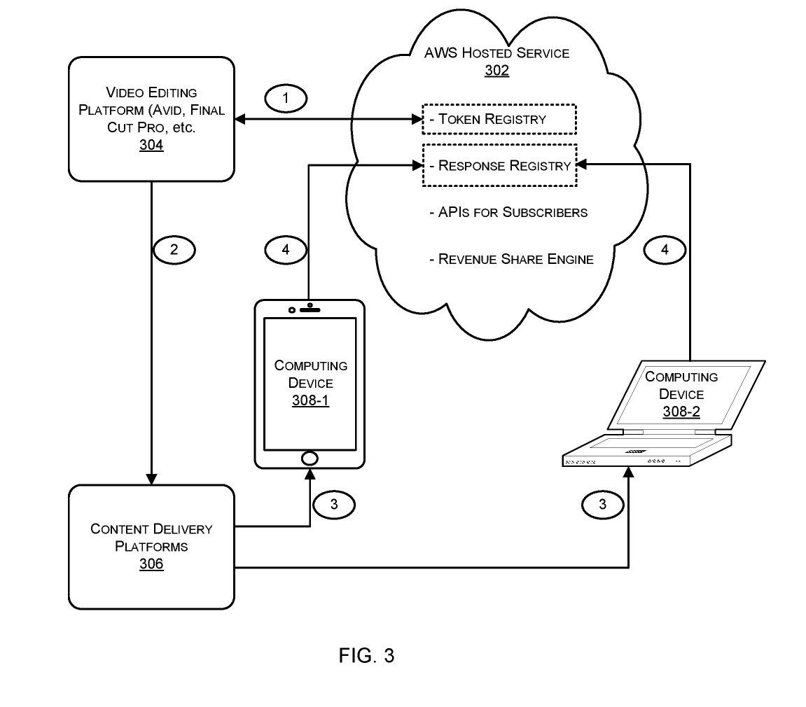

FIG. 3 illustrates a high level block diagram and exemplary working of the proposed system, in accordance with an exemplary embodiment of the present disclosure. FIG. 3 illustrates a high level block diagram and engagement flow. FIG. 3 illustrates the 4 major workflows, labeled 1 to 4.

As shown in FIG. 3, Workflow 1 depicts a video editing platform 304 for encoding content with tokens. As content (ad videos) are created, the system can provide a mechanism, integrated as a “plug-in” with popular video editing tools, for the content producer to supplement the video/audio assets with tokens. The Token registry, a cloud based platform 302 offered by system can generate a universally unique Token (an alphanumeric value) from a Token registry that is specifically associated with the asset. The Token can be presented to the video editing tool 304 for insertion, as private data in a private data elementary data component of the asset. This uniquely tags the video asset for subsequent identification, especially during video play-out by a viewer. The Token can be encapsulated by Packet Identifier (PID) so that it may be PID filtered by video players. Metadata associated with the video asset is also associated with the Token in the token registry. Metadata may include asset name, advertiser ID, fulfillment links (URLs), among others. The metadata can be used when viewers engage with (click) the content to bookmark, or engage in richer experience, and for advertisers and cable operators to account for the engagement.

Workflow 2 depicts video ad asset content delivery platforms (CDP) or content delivery platform 306 can store and package content for distribution over IP to mobile/desktop devices and via the cable plant's RF QAM network to consumer premise digital broadband gateways and set top boxes. The unique Token and PID can be maintained with the video asset in the content delivery platform 306. The CDP 306 may be thought of as an Ad server. Video assets in the CDP 306 can subsequently be used to stream to OTT devices via IPTV networks. The PID/Unique Token can preserve in the stream. The video assets may also be distributed through the cable plant's RF QAM network. Cable operators frequently groom transport streams to filter unknown PIDs to control distribution of data content that is not eligible for carriage. When distributed through the QAM network, the system participating cable operators agree not to filter PIDs/Tokens, since they are participating in a revenue share model for subscriber (viewer) click behavior.

As shown in FIG. 3, content delivery platforms 306 can stream to consumer devices 308-1, 308-2 (workflow 3). Viewers request video content from mobile and browser based video players provided by OTT video providers or cable operators (such as Comcast s Xfinity mobile app or the Frontier Communications My Frontier mobile app). The application can be updated to parse the PID and access the unique Token ID. Display a non-obtrusive graphical watermark with the video to indicate that the Ad content is “Clickable Moment”. The graphical watermark is a PNG (Portable Network Graphics) file that can be selected or created by the video ad asset owner to meet any content use policies that may apply to the video asset. If the viewer touch the screen, during the “Clickable Moment, a message is sent to the system “Response Repository”.

Workflow 4 depicts that based on engagement rules defined in the Response Repository associated with the metadata created at the time of the Token encoding, viewers will either be able to bookmark the “Clickable Moment”, or immediately have a richer engagement with internet hosted content that can be associated with the video ad asset (for example, pop-up a long tail video ad or a new tab with content that may be viewed). The parsing operation can be performed after the content decodes/decryption process, in the same manner by which other data in an elementary stream is parsed and processed (such as EIA-708 closed caption content).

As shown in FIG. 3, the viewer, advertiser, and cable operator can subsequently learn about the viewer engagement via a dashboard for service subscribers (Advertisers, Cable Operators), unique portals and applications for Viewers, which can be developed by advertisers or Cable Operators, using the Restful APIs for subscribers revenue share among advertisers, cable operators, and system can be reconciled continuously, at the time of Clickable engagement by viewers.

The workflow 1-4 that has just been presented, assumes that ad content can be encoded with PIDs and Tokens at the time of video asset encoding. This is performed by the actual content producers, ad agencies, or at any point prior to the hosting of the video ad assets in the CDP 306. In this model, the only considerations for the cable operator are: Do not filter out the PID/Token during video stream management. Enhance your video player (mobile, browser, and/or STB) to parse the PID and interact with the Response Repository. In an embodiment, the system can offer an SDK that can be used by video player developers to provide a PID filter function, the function to display a (variable) graphical watermark, the function to provide engagement responses to the Request Repository, the ability to receive and present rich media (long tail) experiences and create mobile or web based applications for your subscribers that provide for rich media engagement for their “Clickable Moments” (for example, show bookmarks, stream long tail video, etc.)

In another embodiment, cable operators, have an opportunity to “Token encode” existing content for local ad inserts that have not been previously encoded. If the video ad asset is available as a digital MPEG-2 or H.264/MPEG-4 AVC file, is to use the same video editing solution available to content owners (as described in (workflow 1) Encoding Content with Tokens). This would be performed prior to hosting the video ad assets on the CDP 306 or Ad Server 302.

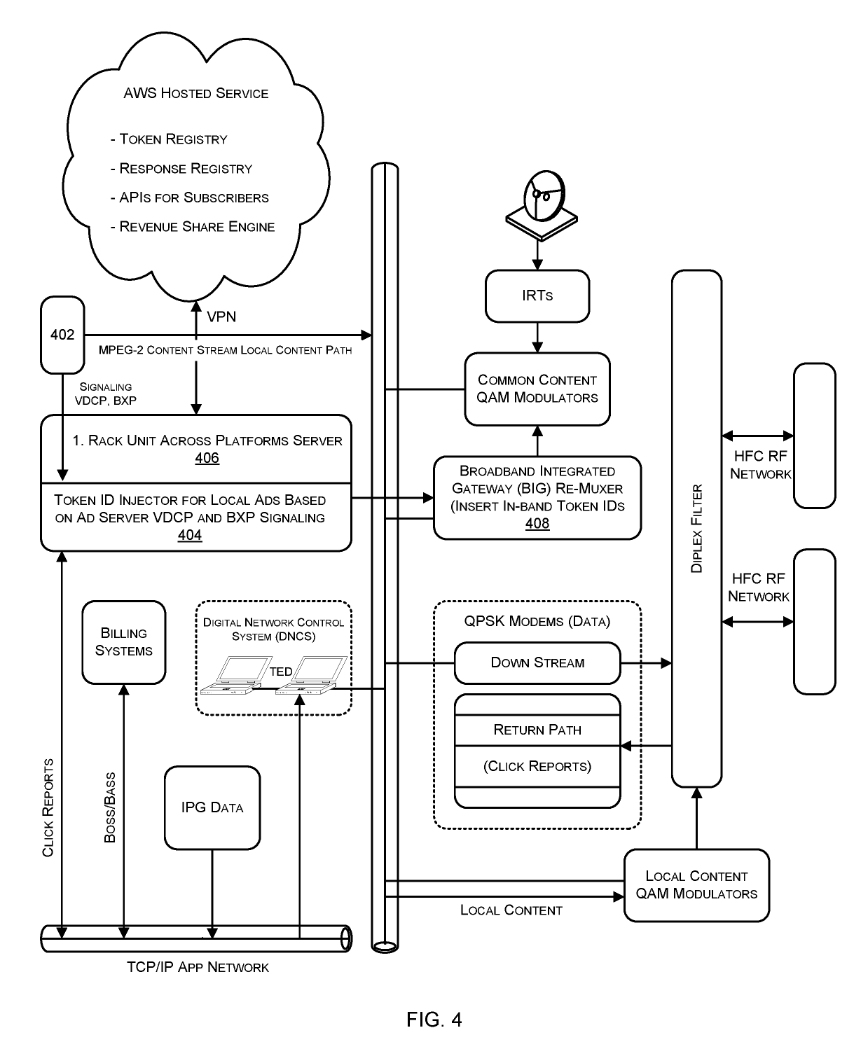

FIG. 4 illustrates integration of a proposed system within a cisco based cable head-end infrastructure and exemplary working of the proposed system, in accordance with an exemplary embodiment of the present disclosure. In an embodiment, real time insertion of Tokens can be performed in the cable head-end, at the point of a transport stream grooming in an encoder/multiplexer

FIG. 4 illustrates the integration of the proposed system within a Cisco based cable head-end infrastructure; a similar integration approach can be accommodated for Arris based systems. In an embodiment, a local ad server (in the system the local ad server can be represented by a TelVue AdCaster) 402 may have content that has pre-encoded PIDs and Tokens, or Ad content that can be sourced without PIDs/Tokens.

In another embodiment, the cable operator can offer Clickable experiences to those advertisers that have not already encoded their video assets. The process for encoding the video assets is as follow: Non Token encoded ads can be identified by their BXF or VDCP metadata 404. This metadata can be used, with a Web based interface to the Token registry to assign unique Tokens that can be accessed in real time by a 1 Rack Unit server 406 installed the head-end, integrated with the broadband integrated Gateway (multiplexer). As a non-Token encoded ad play out, the cloud based Token registry can be interrogated to determine if indeed a unique Token has been created for the ad. If so, the Token can be provided to the 1RU server 406, and the Token can be multiplexed in the private data elementary stream of the content during play out at the point the broadband integrated gateway (multiplexer) 408. At this point, the presentation, and recognition of the Token in the ad stream can be enabled in the digital video player (in this case, as indicated in FIG. 4, the QAM based set tops, and also in the digital IP streams provided to mobile and desktop player apps). From the perspective of the cable operator, integration of the 1RU Across Platforms server 406 requires, a VPN to the Cloud based Token Registry and Response Repository Restful APIs, Input from, and access to, the messaging protocol of the local ad server(s) 402, Access to an input to the local “Broadband Integrated Gateway” or other multiplexer 408 to insert PID/Tokens into the program stream of previously non-encoded ads. The ability to use return channel from consumer premise equipment (broadband gateways or set top boxes). It is recommended that this is accomplished via IP (CMTS). Rack space and power. For every edge “Broadband Integrated Gateway” or multiplexer 408 in a cable network, 1 RU server 406 can be installed. In addition, the cable operator can be trained on the process to use the Token Registry interface to prepare non encoded Ad content as Clickable Ad sales are established with local advertisers, or those who have not previously Token encoded their Ad content.

In another exemplary embodiment, it may be appreciated that the cable companies can buy their own servers, download and set up the present invention implemented in the form of software (like how Weather Channel local channels are set up). The servers can be physically connected to the inputs of the local encoders/multiplexers. Sometime these are IP connections (Ethernet), but sometimes (Harris encoders' etc.) these are physical connections via RS-232, RS-422, RS-485 for data ingest. In those case, the present invention verifies that the physical interconnect can be established and/or confirms if the servers are compatible (can run the virtual machine (VM)) that contains token insertion process proposed by the present invention.

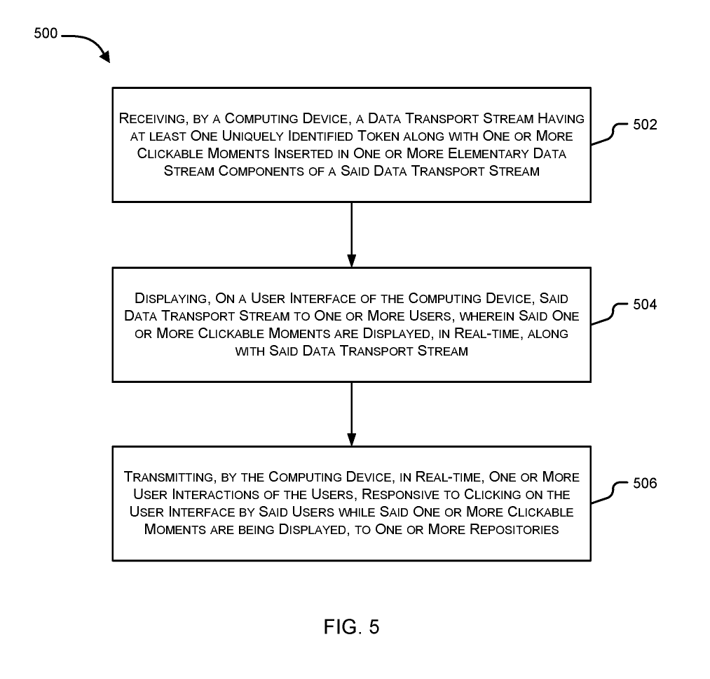

It may be appreciated that, all the components provide in FIG. 5 are not numbered and should be appreciated that these are non-essential components from the present inventions perspective and are not discussed here to avoid any confusion in deciding the protection scope of the present invention.

FIG. 5 illustrates an exemplary flow diagram representing method performed by the proposed system, in accordance with an exemplary embodiment of the present disclosure. The method may be described in the general context of computer executable instructions. Generally, computer executable instructions can include routines, programs, objects, components, data structures, procedures, modules, functions, etc., that perform particular functions or implement particular abstract data types. The method 600 may also be practiced in a distributed computing environment where functions are performed by remote processing devices that are linked through a communications network. In a distributed computing environment, computer executable instructions may be located in both local and remote computer storage media, including memory storage devices.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above proposed system.

At block 502, a data transport stream having at least one uniquely identified token along with one or more clickable moments inserted in one or more elementary data stream components of a said data transport stream can receive by a computing device.

At block 504, display, on a user interface of the computing device, said data transport stream to one or more users, wherein said one or more clickable moments are displayed, in real-time, along with said data transport stream

At block 506, one or more user interactions of the users, responsive to clicking on the user interface by said users while said one or more clickable moments are being displayed, to one or more repositories can be transmitted in real time by a computing device.

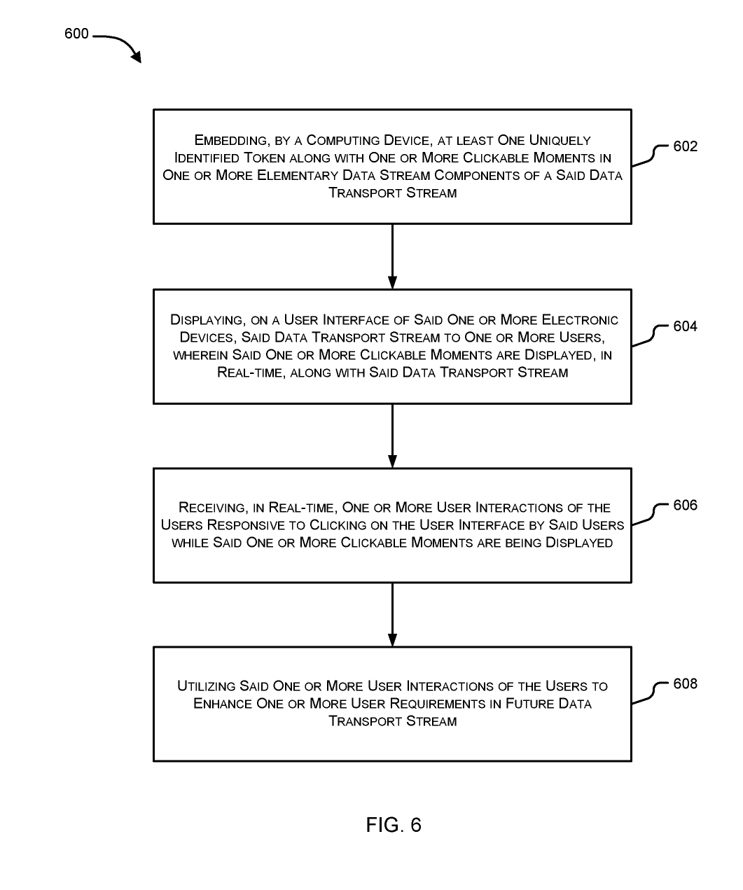

FIG. 6 illustrates an exemplary flow diagram representing method performed by the proposed system, in accordance with an exemplary embodiment of the present disclosure. The method may be described in the general context of computer executable instructions. Generally, computer executable instructions can include routines, programs, objects, components, data structures, procedures, modules, functions, etc., that perform particular functions or implement particular abstract data types. The method 700 may also be practiced in a distributed computing environment where functions are performed by remote processing devices that are linked through a communications network. In a distributed computing environment, computer executable instructions may be located in both local and remote computer storage media, including memory storage devices.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above proposed system.

At block 602, at least one uniquely identified token along with one or more clickable moments in one or more elementary data stream components of a said data transport stream can be embedded with a computing device.

At block 604, displaying, on a user interface of said one or more electronic devices, said data transport stream to one or more users, wherein said one or more clickable moments are displayed, in real-time, along with said data transport stream.

At block 606, receiving, in real-time, one or more user interactions of the users responsive to clicking on the user interface by said users while said one or more clickable moments are being displayed.

At block 608, utilizing said one or more user interactions of the users to enhance one or more user requirements in future data transport stream.

In one of the embodiments, a user can configure the system according to his/her needs. For example, the viewer may not want to have any alcohol related Object ads, effectively making them non-selectable. A viewer interested in buying a car may configure a filter such that it only sees car and related Object's details as it hovers over a frame. Another viewer may only want to see handbag and shoe Objects and so on. The viewer can also configure how he or she wants to see the selected items, such as by hovering over it, view the specifics right away, and view them later or any combination thereof. In another enhancement, a viewer has the ability to filter the objects by category. For example, a viewer may only be interested in automatically learning more about the all the dresses in the Program such as Academy Awards, without having to select one or more dresses.

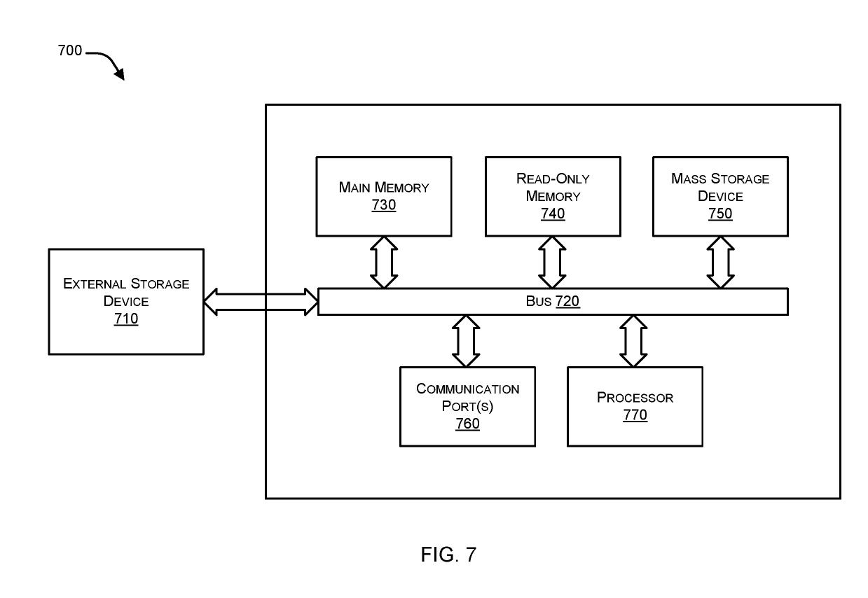

FIG. 7 illustrates an exemplary computer system utilized for implementation of the proposed system in accordance with an exemplary embodiment of the present disclosure. In an embodiment, proactive network security assessment based on benign variants of known threats can be implemented in the computer system 700 to enable aspects of the present disclosure. Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware. As shown in the figure, computer system 700 includes an external storage device 710, a bus 720, a main memory 730, a read only memory 740, a mass storage device 750, communication port 760, and a processor 770. A person skilled in the art will appreciate that computer system 700 may include more than one processor and communication ports. Examples of processor 770 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 770 may include various modules associated with embodiments of the present invention. Communication port 760 can be any of an RS-232 port for use with a modem based dialup connection, a 10/100 Ethernet port, a Gigabit or 10 Gigabit port using copper or fiber, a serial port, a parallel port, or other existing or future ports. Communication port 760 may be chosen depending on a network, such a Local Area Network (LAN), Wide Area Network (WAN), or any network to which computer system 700 connects. Memory 730 can be Random Access Memory (RAM), or any other dynamic storage device commonly known in the art. Read only memory 740 can be any static storage device(s) e.g., but not limited to, a Programmable Read Only Memory (PROM) chips for storing static information e.g., start-up or BIOS instructions for processor 770. Mass storage 750 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc. Bus 820 communicatively couples processor(s) 770 with the other memory, storage and communication blocks. Bus 720 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 770 to software system. Optionally, operator and administrative interfaces, e.g. a display, keyboard, and a cursor control device, may also be coupled to bus 720 to support direct operator interaction with computer system 700. Other operator and administrative interfaces can be provided through network connections connected through communication port 760. External storage device 710 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

Although the proposed system has been elaborated as above to include all the main modules, it is completely possible that actual implementations may include only a part of the proposed modules or a combination of those or a division of those into sub-modules in various combinations across multiple devices that can be operatively coupled with each other, including in the cloud. Further the modules can be configured in any sequence to achieve objectives elaborated. Also, it can be appreciated that proposed system can be configured in a computing device or across a plurality of computing devices operatively connected with each other, wherein the computing devices can be any of a computer, a laptop, a smartphone, an Internet enabled mobile device and the like. All such modifications and embodiments are completely within the scope of the present disclosure.

As used herein, and unless the context dictates otherwise, the term “coupled to” is intended to include both direct coupling (in which two elements that are coupled to each other or in contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While some embodiments of the present disclosure have been illustrated and described, those are completely exemplary in nature. The disclosure is not limited to the embodiments as elaborated herein only and it would be apparent to those skilled in the art that numerous modifications besides those already described are possible without departing from the inventive concepts herein. All such modifications, changes, variations, substitutions, and equivalents are completely within the scope of the present disclosure. The inventive subject matter, therefore, is not to be restricted except in the spirit of the appended claims.

What is claimed is:

1. A computing device, comprising
a non-transitory storage device having embodied therein one or more routines operable to enhance user interaction experience with a data transport stream displayed as advertisements on said computing device; and
one or more processors coupled to the non-transitory storage device and operable to execute the one or more routines, wherein the one or more routines include:
a user interaction engine, which when executed by the one or more processors:
receives, said data transport stream having at least one uniquely identified token along with one or more clickable moments inserted in one or more elementary data stream components of a said data transport stream;
displays, on a user interface of the computing device, said data transport stream to one or more users, wherein said one or more clickable moments are displayed, in real-time, along with said data transport stream; and
transmits, in real-time, one or more user interactions of the users, responsive to clicking on the user interface by said users while said one or more clickable moments are being displayed, to one or more repositories.

2. The computing device as claimed in claim 1, wherein the user interaction engine is configured to bookmark, responsive to clicking, said clickable moments if one or more engagement rules defined in said response repository associated with a metadata created at the time of insertion of the uniquely identified token in said elementary data stream components.

3. The computing device as claimed in claim 1, wherein the user interaction engine is configured to open a new web page, responsive to clicking, having a link embedded in said clickable moments if one or more engagement rules defined in said response repository associated with a metadata created at the time of insertion of the uniquely identified token in said elementary data stream components.

4. The computing device as claimed in claim 1, wherein said one or more clickable moments are displayed as non-obtrusive graphical watermark while said data transport stream is displayed to one or more users.

5. The computing device as claimed in claim 1, wherein said uniquely identified token is associated with a packet ID (PID) of at least one packet generated by a database.

6. The computing device as claimed in claim 1, wherein said uniquely identified token is parsable and/or filtered while said data transport stream is displayed to one or more users such that said users, by clicking on the user interface, engages with one or more contents associated with said uniquely identified token to remember (bookmark) the experience or enable a deeper viewing or interactive experience in real-time.

7. The computing device as claimed in claim 1, wherein said data transport stream is a video transport stream.

8. A method comprising:
receiving, by a computing device, a data transport stream having at least one uniquely identified token along with one or more clickable moments inserted in one or more elementary data stream components of a said data transport stream;
displaying, on a user interface of the computing device, said data transport stream to one or more users, wherein said one or more clickable moments are displayed, in real-time, along with said data transport stream; and
transmitting, by the computing device, in real-time, one or more user interactions of the users, responsive to clicking on the user interface by said users while said one or more clickable moments are being displayed, to one or more repositories.

9. The method as claimed in claim 8 further comprising: utilizing said one or more user interactions of the users to enhance one or more user requirements in future data transport stream.

10. A computing device, comprising
a non-transitory storage device having embodied therein one or more routines operable to enhance user interaction experience with a data transport stream displayed as advertisements on one or more electronic devices; and
one or more processors coupled to the non-transitory storage device and operable to execute the one or more routines, wherein the one or more routines include:
a user interaction engine, which when executed by the one or more processors:
embeds at least one uniquely identified token along with one or more clickable moments in one or more elementary data stream components of a said data transport stream;
displays, on a user interface of said one or more electronic devices, said data transport stream to one or more users, wherein said one or more clickable moments are displayed, in real-time, along with said data transport stream; and
receives, in real-time, one or more user interactions of the users responsive to clicking on the user interface by said users while said one or more clickable moments are being displayed; and
utilize said one or more user interactions of the users to enhance one or more user requirements in future data transport stream.

11. The computing device as claimed in claim 10, wherein said one or more clickable moments are displayed as non-obtrusive graphical watermark while said data transport stream is displayed to one or more users.

12. The computing device as claimed in claim 10, wherein said uniquely identified token is associated with a packet ID (PID) of at least one packet generated by a database.

13. The computing device as claimed in claim 10, wherein said uniquely identified token is parsable and/or filtered while said data transport stream is displayed to one or more users such that said users, by clicking on the user interface, engages with one or more contents associated with said uniquely identified token to remember (bookmark) the experience or enable a deeper viewing or interactive experience in real-time.

14. The computing device as claimed in claim 10, wherein said data transport stream is a video transport stream.

15. A method comprising:
embedding, by a computing device, at least one uniquely identified token along with one or more clickable moments in one or more elementary data stream components of a said data transport stream;
displaying, on a user interface of said one or more electronic devices, said data transport stream to one or more users, wherein said one or more clickable moments are displayed, in real-time, along with said data transport stream;
receiving, in real-time, one or more user interactions of the users responsive to clicking on the user interface by said users while said one or more clickable moments are being displayed; and
utilizing said one or more user interactions of the users to enhance one or more user requirements in future data transport stream.
